(19) United States
(12) Patent Application Publication
(10) Pub. No.: US 2026/0158792 A1
(43) Pub. Date: Jun. 11, 2026

(54) LIQUID DISCHARGE HEAD DEVICE, LIQUID DISCHARGE UNIT, AND LIQUID DISCHARGE APPARATUS

(71) Applicant: Tsuguyori KEMMA, Kanagawa (JP)

(72) Inventor: Tsuguyori KEMMA, Kanagawa (JP)

(21) Appl. No.: 19/370,782

(22) Filed: Oct. 28, 2025

(30) Foreign Application Priority Data
Dec. 6, 2024 (JP) 2024-213776

(51) Int. Cl. B41J 2/17; B41J 2/165; B41J 25/00; B41J 29/377

(52) U.S. Cl. CPC B41J 2/1714; B41J 2/165; B41J 25/005; B41J 29/377; B41J 2002/16582

(57) ABSTRACT

A liquid discharge head device includes a liquid discharge head and a head holder. The liquid discharge head has a nozzle face having a nozzle to discharge a liquid, from the nozzle in a discharge direction, onto a discharge target conveyed in a conveyance direction orthogonal to the discharge direction. The head holder holds the liquid discharge head having the nozzle face facing in the discharge direction. The head holder has an opposing face facing in the discharge direction and an exhaust port on the opposing face and in a vicinity of the nozzle face.

### CROSS-REFERENCE TO RELATED APPLICATION

This patent application is based on and claims priority pursuant to 35 U.S.C. § 119(a) to Japanese Patent Application No. 2024-213776, filed on Dec. 6, 2024, in the Japan Patent Office, the entire disclosure of which is hereby incorporated by reference herein.

### BACKGROUND

### Technical Field

The present disclosure relates to a liquid discharge head device, a liquid discharge unit, and a liquid discharge apparatus.

### Related Art

In the related art, a liquid discharge head device includes a liquid discharge head that discharges a liquid from a nozzle formed on a nozzle face onto a discharge target medium being conveyed.

### SUMMARY

The present disclosure described herein provides an improved liquid discharge head device including a liquid discharge head and a head holder. The liquid discharge head has a nozzle face having a nozzle to discharge a liquid, from the nozzle in a discharge direction, onto a discharge target conveyed in a conveyance direction orthogonal to the discharge direction. The head holder holds the liquid discharge head having the nozzle face facing in the discharge direction. The head holder has an opposing face facing in the discharge direction and an exhaust port on the opposing face and in a vicinity of the nozzle face.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming system;

FIG. 2 is a diagram illustrating a head unit of the image forming system of FIG. 1 as viewed in a direction perpendicular to the surface of a continuous sheet facing the head unit;

FIG. 3 is an external perspective view of a liquid discharge head of the head unit of FIG. 2;

FIG. 4 is a cross-sectional view of the liquid discharge head of FIG. 3, orthogonal to a nozzle array direction;

FIG. 5 is a cross-sectional view of a head array cut in a sheet conveyance direction;

FIG. 6 is a diagram illustrating a configuration of an exhaust device of the head array of FIG. 5;

FIG. 7 is a cross-sectional view of a head array cut in a sheet conveyance direction, according to a modification;

FIG. 8 is a diagram illustrating a configuration of an exhaust device of the head array of FIG. 7;

FIG. 9 is a plan view of a part of a liquid discharge apparatus;

FIG. 10 is a side view of the part of the liquid discharge apparatus of FIG. 9;

FIG. 11 is a plan view of a part of a liquid discharge unit;

FIG. 12 is a front view of another liquid discharge unit; and

FIG. 13 is a schematic view of an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the following description, a liquid discharge head device according to an embodiment of the present disclosure is applied to an image forming system including an image forming apparatus. The image forming apparatus includes an inkjet printer as a liquid discharge apparatus.

The present disclosure is not limited to any particular type of the liquid discharge head, and can be applied to any type, such as a piezoelectric liquid discharge head, a bubble jet (registered trademark) liquid discharge head, and an electrostatic liquid discharge head.

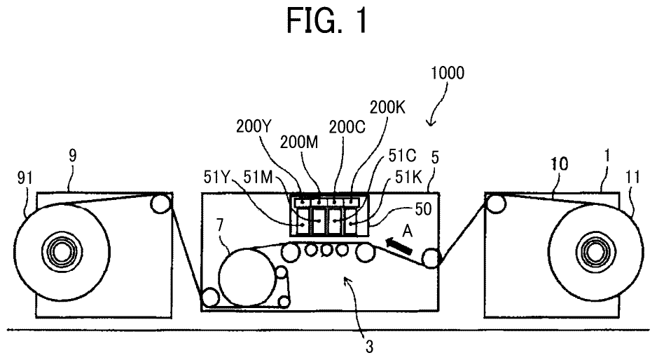

FIG. 1 is a schematic diagram illustrating a configuration of an image forming system 1000.

The image forming system 1000 includes an unwinding apparatus 1, an image forming apparatus 5, and a winding apparatus 9. The unwinding apparatus 1 conveys a continuous sheet 10 which is a continuous body as a discharge target medium (may be referred to simply as a discharge target). The image forming apparatus 5 discharges a liquid onto the continuous sheet 10 conveyed by the unwinding apparatus 1 to form an image. The winding apparatus 9 winds the continuous sheet 10, on which the image is formed, ejected from the image forming apparatus 5. The image forming apparatus 5 includes a conveyor 3 and a dryer 7. The conveyor 3 conveys the continuous sheet 10 conveyed by the unwinding apparatus 1, to a head unit 50. The dryer 7 dries the continuous sheet 10 on which the image is formed.

The continuous sheet 10 is fed out from a sheet roll 11 of the unwinding apparatus 1, conveyed by rollers of the unwinding apparatus 1, the conveyor 3, the dryer 7, and the winding apparatus 9, and wound by a printed roll 91 of the winding apparatus 9. In the image forming apparatus 5, the continuous sheet 10 is conveyed so as to face the head unit 50, and an image is formed by discharging a liquid (e.g., ink for image formation) from the head unit 50.

In the head unit 50, for example, full-line head arrays 51K, 51C, 51M, and 51Y for four colors and liquid circulation mechanisms 200K, 200C, 200M, and 200Y respectively corresponding to head arrays 51K, 51C, 51M, and 51Y are arranged in this order from the upstream side in a sheet conveyance direction A (conveyance direction of the discharge target medium). Each of the head arrays 51K, 51C, 51M, and 51Y is a liquid discharge head device including one, or two or more liquid discharge heads to discharge liquid of black (K), cyan (C), magenta (M), or yellow (Y) to the continuous sheet 10 being conveyed. Each of the head arrays 51K, 51C, 51M, and 51Y may be referred to simply as a head array 51 unless distinguished.

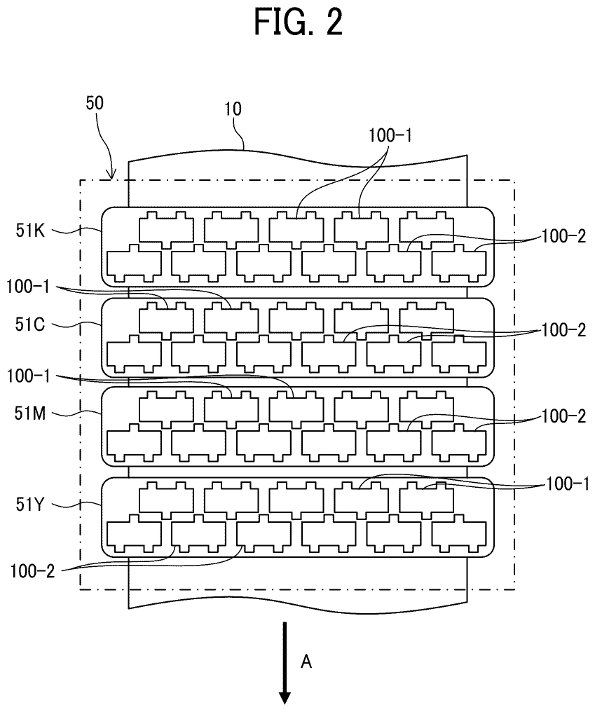

FIG. 2 is a diagram illustrating the head unit 50 as viewed in a direction perpendicular to the surface of the continuous sheet 10 facing the head unit 50.

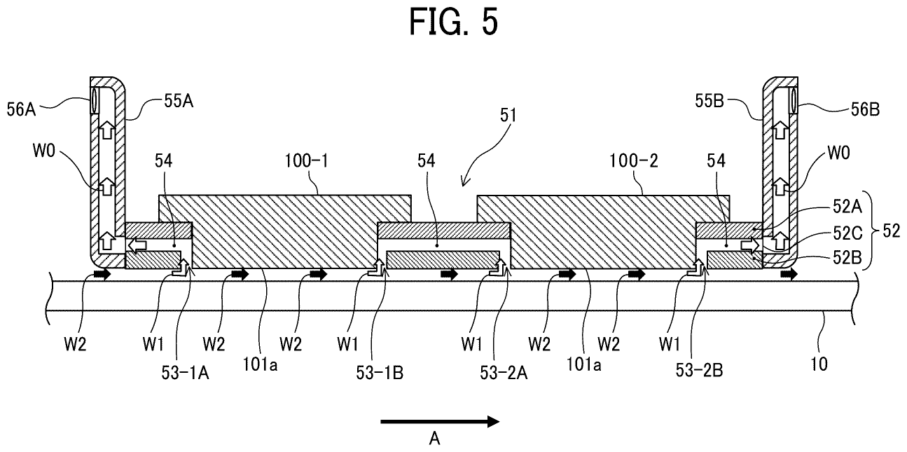

As illustrated in FIG. 2, each of the head arrays 51K, 51C, 51M, and 51Y includes liquid discharge heads 100-1 and 100-2 arranged in a staggered manner on a base 52 (see FIG. 5) as a head holder. Specifically, the multiple liquid discharge heads 100-1 and 100-2 in each of the head arrays 51K, 51C, 51M, and 51Y have nozzles arrayed in a nozzle array direction that coincides with a sheet width direction orthogonal to the sheet conveyance direction A. The positions of the adjacent liquid discharge heads 100-1 and 100-2 are shifted from each other in the sheet conveyance direction A, and the positions of the nozzle arrays of the adjacent liquid discharge heads 100-1 and 100-2 partially overlap each other in the sheet width direction.

In the following description, the liquid discharge head located on the upstream side in the sheet conveyance direction A is referred to as an upstream head 100-1, and the liquid discharge head located on the downstream side in the sheet conveyance direction A is referred to as a downstream head 100-2. Each of the upstream head 100-1 and the downstream head 100-2 may be referred to as the liquid discharge head 100 unless distinguished.

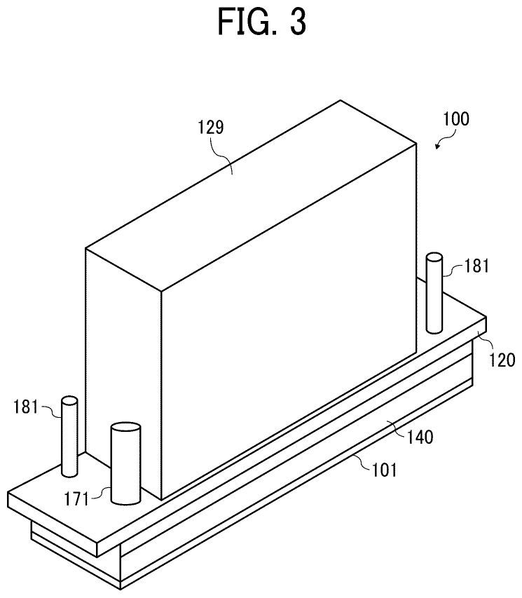

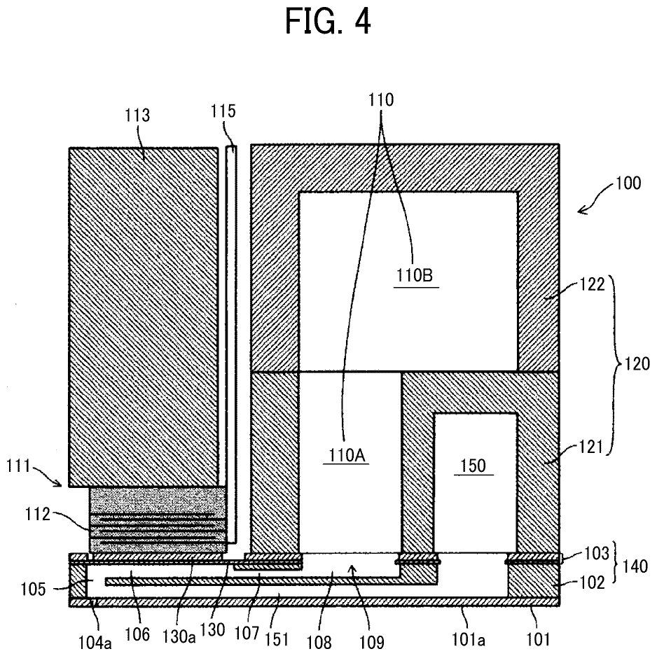

FIG. 3 is an external perspective view of the liquid discharge head 100. FIG. 4 is a cross-sectional view of the liquid discharge head 100 orthogonal to the nozzle array direction.

The liquid discharge head 100 includes a nozzle plate 101, a channel plate 102, and a diaphragm 103 laminated one on another and bonded to each other as a structural portion. The liquid discharge head 100 further includes a piezoelectric actuator 111, a common chamber substrate 120, and a cover 129. The piezoelectric actuator 111 as a pressure generator displaces a vibration portion 130 of the diaphragm 103. The common chamber substrate 120 also serves as a frame of the liquid discharge head 100. A portion including the channel plate 102 and the diaphragm 103 is referred to as a channel substrate 140.

The nozzle plate 101 has multiple nozzles 104a to discharge a liquid. Each nozzle 104a is open on a nozzle face 101a facing the continuous sheet 10. In the liquid discharge head 100, at least two nozzle arrays each including the multiple nozzles 104a arrayed in the nozzle array direction are formed on the nozzle face 101a. In the liquid discharge head 100, for example, four nozzle arrays are arranged in the sheet conveyance direction A, but the number of nozzle arrays is appropriately set.

The channel plate 102 has through holes and grooves that define an individual liquid chamber 106, a supply-side liquid restrictor 107, and a liquid inlet 108. The individual liquid chamber 106 as a pressure chamber communicates with the nozzle 104a via a nozzle communication channel 105. The supply-side liquid restrictor 107 communicates with the individual liquid chamber 106. The liquid inlet 108 communicates with the supply-side liquid restrictor 107. The nozzle communication channel 105 communicates with the nozzle 104a and the individual liquid chamber 106. Further, the liquid inlet 108 communicates with a supply-side common liquid chamber 110 through an opening 109 of the diaphragm 103.

The diaphragm 103 includes the deformable vibration portion 130 serving as a wall of the individual liquid chamber 106 of the channel plate 102. The diaphragm 103 has, but is not limited to, a two-layer structure and includes a first layer forming a thin portion and a second layer forming a thick portion in this order from the channel plate 102. A portion of the first layer corresponding to the individual liquid chamber 106 forms the deformable vibration portion 130.

The piezoelectric actuator 111 is disposed on the side opposite the individual liquid chamber 106 via the diaphragm 103. The piezoelectric actuator 111 includes an electromechanical transducer as a driving device (actuator device or pressure generator) to deform the vibration portion 130 of the diaphragm 103. The piezoelectric actuator 111 includes a piezoelectric element 112 bonded onto a base member 113. The piezoelectric element 112 is grooved by, for example, half-cut dicing to form a comb shape including a desired number of pillar-shaped elements that are arranged at certain intervals. The piezoelectric element 112 is bonded to a projection 130a which is an island-shaped thick portion on the vibration portion 130 of the diaphragm 103. A flexible wiring 115 is connected to the piezoelectric element 112.

The common chamber substrate 120 defines the supply-side common liquid chamber 110 and a delivery-side common liquid chamber 150. The supply-side common liquid chamber 110 communicates with a supply port 171, and the delivery-side common liquid chamber 150 communicates with a delivery port 181. For example, the common chamber substrate 120 includes a first common chamber substrate 121 and a second common chamber substrate 122. The first common chamber substrate 121 is bonded to the diaphragm 103 of the channel substrate 140. The second common chamber substrate 122 is laminated on and bonded to the first common-chamber substrate 121.

The first common chamber substrate 121 defines a downstream common liquid chamber 110A and the delivery-side common liquid chamber 150. The downstream common liquid chamber 110A is a portion of the supply-side common liquid chamber 110 communicating with the liquid inlet 108. The delivery-side common liquid chamber 150 communicates with a delivery channel 151. The second common chamber substrate 122 defines an upstream common chamber 110B which is the other portion of the supply-side common liquid chamber 110. The channel plate 102 further defines the delivery channel 151 extending in the in-plane direction of the channel plate 102. The delivery channel 151 communicates with the individual liquid chamber 106 via the nozzle communication channel 105. The delivery channel 151 communicates with the delivery-side common liquid chamber 150.

In the liquid discharge head 100, for example, the voltage to be applied to the piezoelectric element 112 is lowered from a reference potential (intermediate potential) so that the piezoelectric element 112 contracts to pull the vibration portion 130 of the diaphragm 103 to increase the volume of the individual liquid chamber 106. As a result, liquid flows into the individual liquid chamber 106. When the voltage applied to the piezoelectric element 112 is raised, the piezoelectric element 112 expands in the direction of lamination thereof. As a result, the vibration portion 130 of the diaphragm 103 deforms in the direction toward the nozzle 104a and reduces the volume of the individual liquid chamber 106. Thus, liquid in the individual liquid chamber 106 is pressurized and discharged from the nozzle 104a.

The liquid in the individual liquid chamber 106 that has not been discharged from the nozzle 104a is delivered to the delivery-side common liquid chamber 150 through the delivery channel 151. Then, the liquid is delivered from the delivery-side common liquid chamber 150 to an external liquid circulation path (e.g., a liquid circulation device) and supplied to the supply-side common liquid chamber 110 again through the external liquid circulation path. The method of driving the liquid discharge head is not limited to the above-described example (pull-push discharge). For example, pull discharge or push discharge may be performed in accordance with the way to apply a drive waveform.

For example, water vapor or ink mist contained in air around the nozzle face 101a of the liquid discharge head 100 may be condensed, and liquid (e.g., condensed water or ink) may adhere to the nozzle face 101a. A description is given below of a configuration for preventing the liquid, such as water droplets and ink droplets, from adhering to the nozzle face 101a.

In a comparative example, an exhaust mechanism separated from the liquid discharge head device may be used to exhaust the air containing water vapor or ink mist around a nozzle face of a liquid discharge head. In the comparative example, the exhaust port is too far from the nozzle face of the liquid discharge head, and thus, air around the nozzle face is not sufficiently exhausted. As a result, liquid such as water droplets and ink droplets may adhere to the nozzle face, for example, due to condensation. If the momentum of the airflow sucked from the exhaust port is increased to sufficiently exhaust the air around the nozzle face, a discharge direction of the liquid to be discharged from the nozzle may be changed by the airflow, and appropriate liquid discharge is hindered.

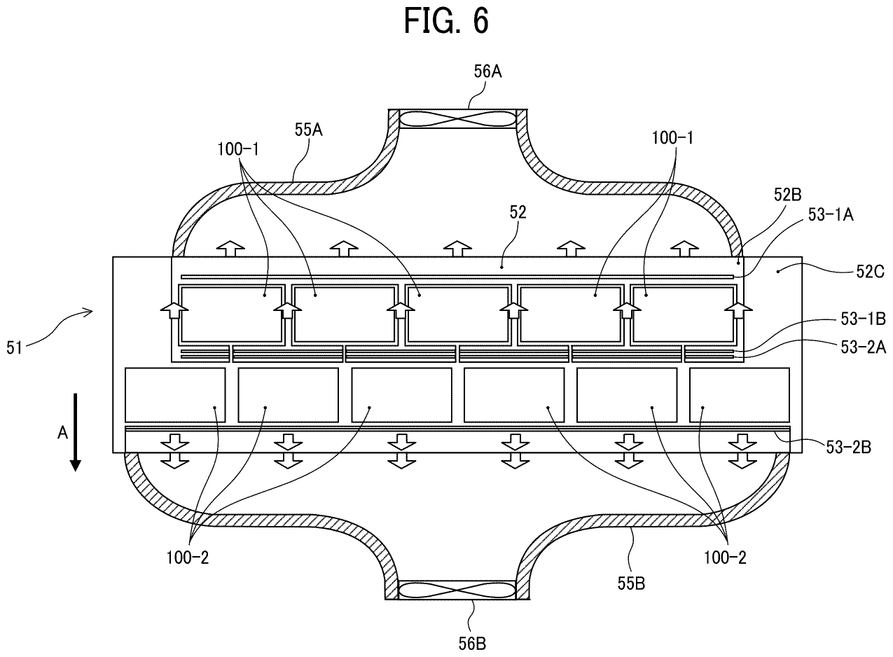

FIG. 5 is a cross-sectional view of the head array 51 cut in the sheet conveyance direction A. FIG. 6 is a diagram illustrating a configuration of an exhaust device of the head array 51.

The head array 51 includes the base 52 as a head holder to hold the liquid discharge heads 100-1 and 100-2, and has exhaust ports 53-1A, 53-1B, 53-2A, and 53-2B on an opposing face of the base 52 facing the continuous sheet 10. In other words, the opposing face faces in the discharge direction. Specifically, the base 52 includes two plates: an upper plate 52A and a lower plate 52B. The upper plate 52A and the lower plate 52B face each other with a gap to form a space therebetween. The exhaust ports 53-1A, 53-1B, 53-2A, and 53-2B are open in the lower plate 52B facing the continuous sheet 10 (i.e., the opposing face).

The base 52 further includes a spacer 52C sandwiched between the upper plate 52A and the lower plate 52B to form the space between the upper plate 52A and the lower plate 52B. The space between the upper plate 52A and the lower plate 52B communicates with the exhaust ports 53-1A, 53-1B, 53-2A, and 53-2B to define an exhaust channel 54. The exhaust channel 54 in the base 52 communicates with exhaust ducts 55A and 55B. Suction fans 56A and 56B as suction devices are disposed at ends of the exhaust ducts 55A and 55B, respectively. In other words, the exhaust ducts 55A and 55B and the suction fans 56A and 56B function as an exhaust device to exhaust the air around the nozzle face 101a. The exhaust channel 54 connects the exhaust device and the exhaust ports 53-1A, 53-1B, 53-2A, and 53-2B to guide the air from the the exhaust ports 53-1A, 53-1B, 53-2A, and 53-2B to the exhaust device. In other words, the exhaust channel 54 guides air entered from the exhaust ports 53-1A, 53-1B, 53-2A, and 53-2B in a direction parallel to the sheet conveyance direction A.

As the suction fans 56A and 56B are driven, airflow W0 directed toward the suction fans 56A and 56B is generated in the exhaust ducts 55A and 55B and the exhaust channel 54. As a result, suction airflow W1 for sucking external air between the continuous sheet 10 and the head array 51 is generated at the exhaust ports 53-1A, 53-1B, 53-2A, and 53-2B communicating with the exhaust channel 54. As a result, the external air flows into the exhaust channel 54 in the base 52 from the exhaust ports 53-1A, 53-1B, 53-2A, and 53-2B, and is exhausted from the suction fans 56A and 56B via the exhaust ducts 55A and 55B.

The base 52 holding the liquid discharge heads 100-1 and 100-2 has the exhaust ports 53-1A, 53-1B, 53-2A, and 53-2B. As a result, the exhaust ports 53-1A, 53-1B, 53-2A, and 53-2B can be disposed in the vicinity of the respective nozzle faces 101a of the liquid discharge heads 100-1 and 100-2 held by the base 52. Thus, as compared with the comparative example in which an exhaust port is disposed at a position far from the nozzle face of the liquid discharge head, the air containing water vapor or ink mist around the nozzle face 101a can be quickly exhausted. As a result, liquid (e.g., condensed liquid), such as water droplets and ink droplets, can be prevented from adhering to the nozzle face 101a.

In particular, in FIG. 5, the exhaust ports 53-1A, 53-1B, 53-2A, and 53-2B are disposed on both the upstream side and the downstream side of the respective nozzle faces 101a of the liquid discharge heads 100-1 and 100-2 in the sheet conveyance direction A. In other words, the exhaust port 53-1A is open (has an opening) on the upstream side of the upstream head 100-1 in the sheet conveyance direction A, and the exhaust port 53-1B is open (has an opening) on the downstream side of the upstream head 100-1 in the sheet conveyance direction A. The exhaust port 53-2A is open (has an opening) on the upstream side of the downstream head 100-2 in the sheet conveyance direction A, and the exhaust port 53-2B is open (has an opening) on the downstream side of the downstream head 100-2 in the sheet conveyance direction A.

Due to such a configuration, the air facing the nozzle face 101a can be exhausted through the exhaust ports 53-1A, 53-1B, 53-2A, and 53-2B by the suction airflow W1 on both the upstream side and the downstream side of the respective nozzle faces 101a in the sheet conveyance direction A. Thus, the air around the nozzle face 101a can be exhausted by the suction airflow W1 with a smaller momentum.

In FIG. 5, the exhaust ports 53-1A, 53-1B, 53-2A, and 53-2B are disposed on both the upstream side and the downstream side of the respective nozzle faces 101a in the sheet conveyance direction A, but the exhaust port may be disposed on one of the upstream side and the downstream side.

The exhaust port may be disposed at an end of the nozzle face 101a in the nozzle array direction. However, when the nozzle face 101a has an elongated shape extending in the nozzle array direction, the exhaust port at the end portion in the nozzle array direction is located away from the vicinity of the center of the nozzle face 101a in the nozzle array direction. Accordingly, it is difficult to exhaust the air in the vicinity of the center of the nozzle face 101a in the nozzle array direction. Thus, the exhaust port at the end (upstream side or downstream side) of the nozzle face 101a in the sheet conveyance direction (transverse direction of the head) is more preferable than the exhaust port at the end of the nozzle face 101a in the nozzle array direction (longitudinal direction of the head).

Conveyance airflow W2 flowing downstream in the sheet conveyance direction A is generated between the head array 51 and the continuous sheet 10 by the conveyance of the continuous sheet 10 as illustrated in FIG. 5. Thus, the air around the respective nozzle faces 101a of the head array 51 flows downstream along with the conveyance airflow W2 in the sheet conveyance direction A. Accordingly, to exhaust the air around the respective nozzle faces 101a of the head array 51, the exhaust ports 53-1B and 53-2B located on the downstream side of the respective nozzle faces 101a in the sheet conveyance direction A are more efficient than the exhaust ports 53-1A and 53-2A located on the upstream side of the respective nozzle faces 101a in the sheet conveyance direction A.

In particular, as illustrated in FIG. 5, when the multiple liquid discharge heads 100-1 and 100-2 are held at different positions in the sheet conveyance direction A by the base 52 of the head array 51, the head array 51 preferably has the exhaust port 53-2B which is open on the downstream side of the nozzle face 101a of at least the liquid discharge head (downstream head 100-2) located on the most downstream side in the sheet conveyance direction A.

When the conveyance airflow W2 flowing downstream in the sheet conveyance direction A is generated, the exhaust ports 53-1A and 53-2A on the upstream side of the respective nozzle faces 101a in the sheet conveyance direction A may rather lower the exhaust efficiency of the air around the nozzle faces 101a. Specifically, the suction airflow W1 generated at the exhaust ports 53-1A and 53-2A on the upstream side of the respective nozzle faces 101a in the sheet conveyance direction may disturb the conveyance airflow W2 that causes the air around the nozzle face 101a to flow downstream in the sheet conveyance direction A. If the conveyance airflow W2 is disturbed, the air around the nozzle face 101a does not smoothly flow downstream in the sheet conveyance direction A, and the exhaust efficiency by the exhaust ports 53-1B and 53-2B on the downstream side of the respective nozzle faces 101a in the sheet conveyance direction may be lowered.

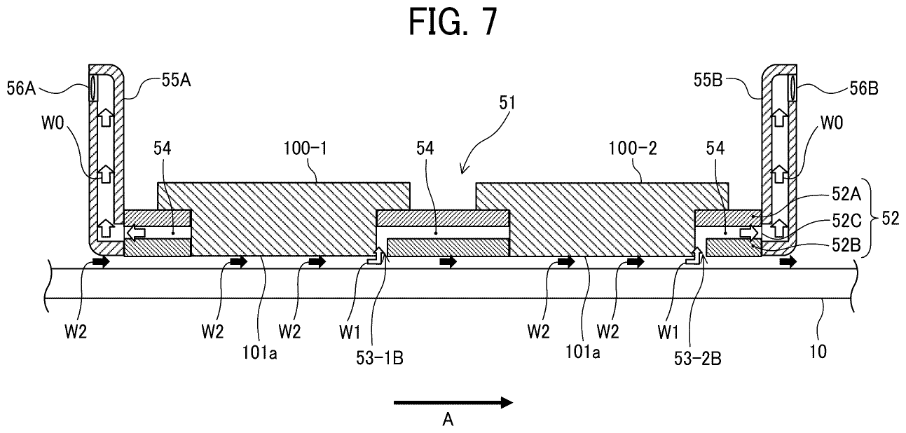

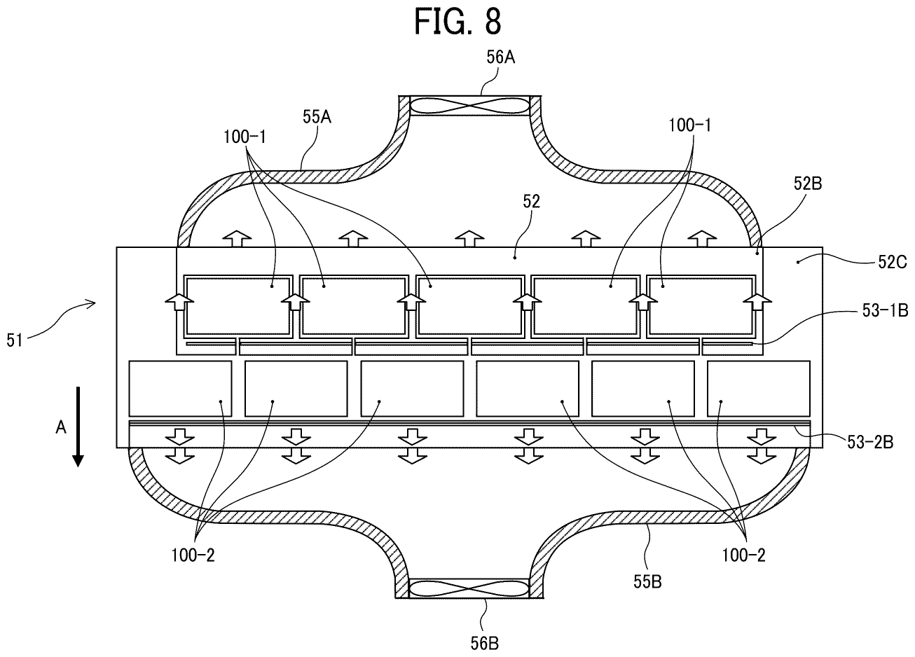

In consideration of this point, as illustrated in FIGS. 7 and 8, only the exhaust ports 53-1B and 53-2B are preferably disposed on the downstream side of the respective nozzle faces 101a of the liquid discharge heads 100-1 and 100-2 in the sheet conveyance direction A without the exhaust ports 53-1A and 53-2A on the upstream side of the respective nozzle faces 101a of the liquid discharge heads 100-1 and 100-2 in the sheet conveyance direction. In other words, the exhaust ports 53-1B and 53-2B open at positions downstream from the respective nozzle faces 101a of the liquid discharge heads 100-1 and 100-2 in the sheet conveyance direction A, but the exhaust ports 53-1A and 53-2A do not open at positions upstream from the respective nozzle faces 101a of the liquid discharge heads 100-1 and 100-2 in the sheet conveyance direction A in FIGS. 7 and 8. Due to this configuration, the conveyance airflow W2 is not disturbed by the exhaust ports 53-1A and 53-2A on the upstream side in the sheet conveyance direction A, and the exhaust efficiency of the air around the nozzle faces 101a can be enhanced.

As illustrated in FIGS. 7 and 8, focusing on the downstream head 100-2, the exhaust ports 53-1B and 53-2B are disposed on the upstream side and the downstream side of the nozzle face 101a of the downstream head 100-2 in the sheet conveyance direction A, respectively. In other words, the exhaust port 53-1B is disposed on the downstream side of the nozzle face 101a of the upstream head 100-1 in the sheet conveyance direction A, and is disposed on the upstream side of the nozzle face 101a of the downstream head 100-2 in the sheet conveyance direction A. Thus, the conveyance airflow W2 that causes the air around the nozzle face 101a of the downstream head 100-2 to flow downstream in the sheet conveyance direction A may be disturbed by the suction airflow W1 sucked through the exhaust port 53-1B. As a result, the exhaust efficiency by the exhaust port 53-2B on the downstream side of the nozzle face 101a of the downstream head 100-2 in the sheet conveyance direction A may be lowered.

In such a case, a flow rate of the suction airflow W1 flowing into the exhaust port 53-2B on the downstream side of the nozzle face 101a of the downstream head 100-2 in the sheet conveyance direction A is preferably larger than a flow rate of the suction airflow W1 flowing into the exhaust port 53-1B on the upstream side of the nozzle face 101a of the downstream head 100-2 in the sheet conveyance direction A. For example, the suction fan 56B that generates the suction airflow W1 to the exhaust port 53-2B on the downstream side of the nozzle face 101a of the downstream head 100-2 in the sheet conveyance direction A has an airflow volume larger than the airflow volume of the suction fan 56A that generates the suction airflow W1 to the exhaust port 53-1B on the upstream side of the nozzle face 101a of the downstream head 100-2 in the sheet conveyance direction A. This configuration can compensate for the decrease in the exhaust efficiency of the air around the nozzle face 101a of the downstream head 100-2 by the exhaust port 53-2B on the downstream side of the nozzle face 101a of the downstream head 100-2 in the sheet conveyance direction A.

Further, airflow may flow into a space between the continuous sheet 10 and the head array 51 in the sheet width direction. In this case, the conveyance airflow W2 that causes the air around the nozzle face 101a to flow downstream in the sheet conveyance direction A may be disturbed by the airflow flowing in the sheet width direction. As a result, the exhaust efficiency of the air around the nozzle face 101a by the exhaust ports 53-1A, 53-1B, 53-2A, and 53-2B may be lowered. In such a case, an airflow restrictor that restricts the airflow from flowing into the space between the continuous sheet 10 and the head array 51 in the sheet width direction.

A specific example of the airflow restrictor includes side walls disposed at both ends of the base 52 in the sheet width direction (nozzle array direction). The side walls project toward the continuous sheet 10 in a direction perpendicular to the surface of the continuous sheet 10 so as to face the ends of the continuous sheet 10 in the sheet width direction.

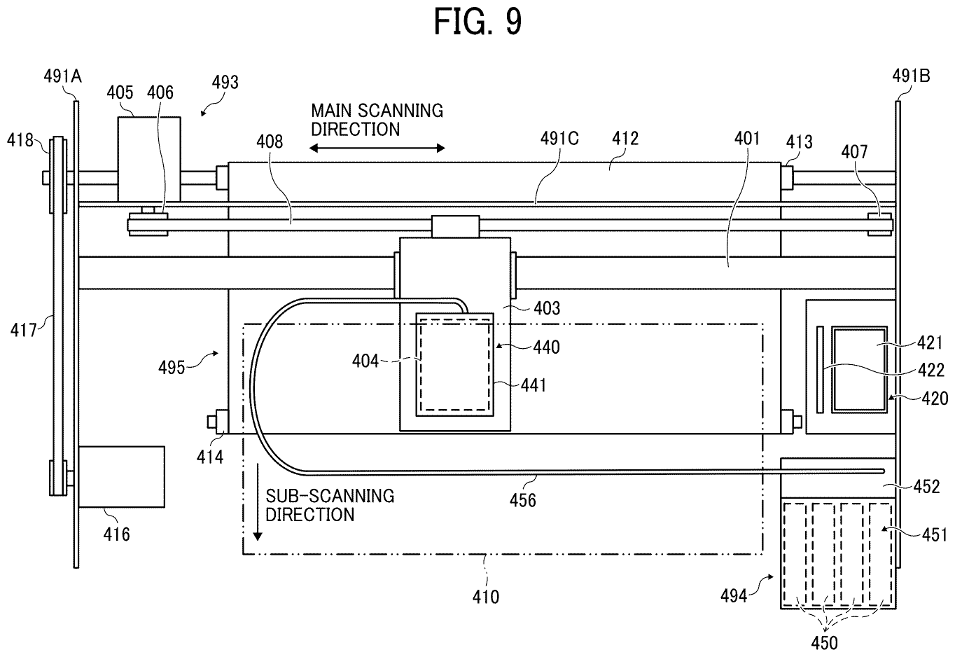

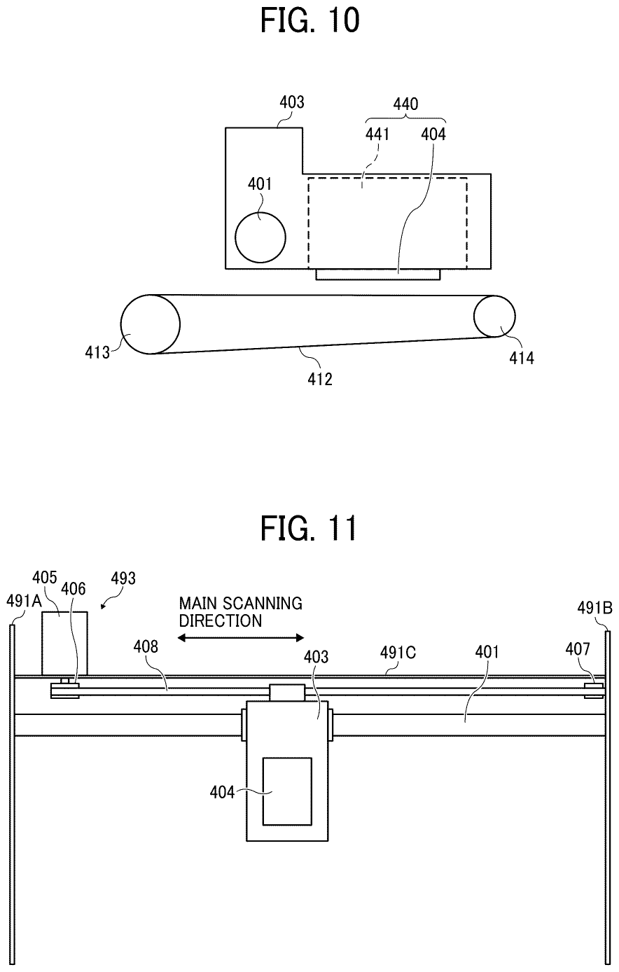

A liquid discharge apparatus is described below with reference to FIGS. 9 and 10. FIG. 9 is a plan view of a part of a liquid discharge apparatus. FIG. 10 is a side view of the part of the liquid discharge apparatus of FIG. 9.

The liquid discharge apparatus is a serial-type apparatus in which a main-scanning moving mechanism 493 reciprocates a carriage 403 in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 carries (mounts) a liquid discharge unit 440 including a liquid discharge head device 404 and a head tank 441 as a single integrated unit. The liquid discharge head device 404 of the liquid discharge unit 440 includes, for example, the liquid discharge heads that discharge liquids of the respective colors of yellow (Y), cyan (C), magenta (M), and black (K), similarly to the head unit 50 described above. As the liquid discharge heads of the liquid discharge head device 404, the liquid discharge heads 100 each having a nozzle array including multiple nozzles are arrayed in a staggered manner. The multiple nozzles are arrayed in the nozzle array direction, which is a sub-scanning direction (head longitudinal direction) orthogonal to the main scanning direction, and the liquid discharge heads 100 discharge liquid downward in the discharge direction, similarly to the liquid discharge heads 100 described above. The discharge direction is orthogonal to the sheet conveyance direction A.

A supply mechanism 494 disposed outside the liquid discharge head device 404 supplies liquid stored in liquid cartridges 450 to the head tank 441 to supply the liquid to the liquid discharge head device 404. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the liquid discharge head device 404. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head device 404 is disposed lateral to the conveyance belt 412. The maintenance mechanism 420 includes, for example, a cap 421 to cap the nozzle face (i.e., a face on which nozzles 104a are formed) of the liquid discharge head device 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C. In the liquid discharge apparatus having the above-described configuration, the sheet 410 is fed and attracted onto the conveyance belt 412 and conveyed in the sub-scanning direction as the conveyance belt 412 circumferentially moves.

The liquid discharge head device 404 is driven in response to an image signal while the carriage 403 moves in the main scanning direction to discharge liquid onto the sheet 410 not in motion. As a result, an image is formed on the sheet 410. As described above, the liquid discharge apparatus includes the liquid discharge head, thus allowing the stable formation of high-quality images.

Another liquid discharge unit is described below with reference to FIG. 11. FIG. 11 is a plan view of a part of a liquid discharge unit. The liquid discharge unit includes the housing, the main-scanning moving mechanism 493, the carriage 403, and the liquid discharge head device 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

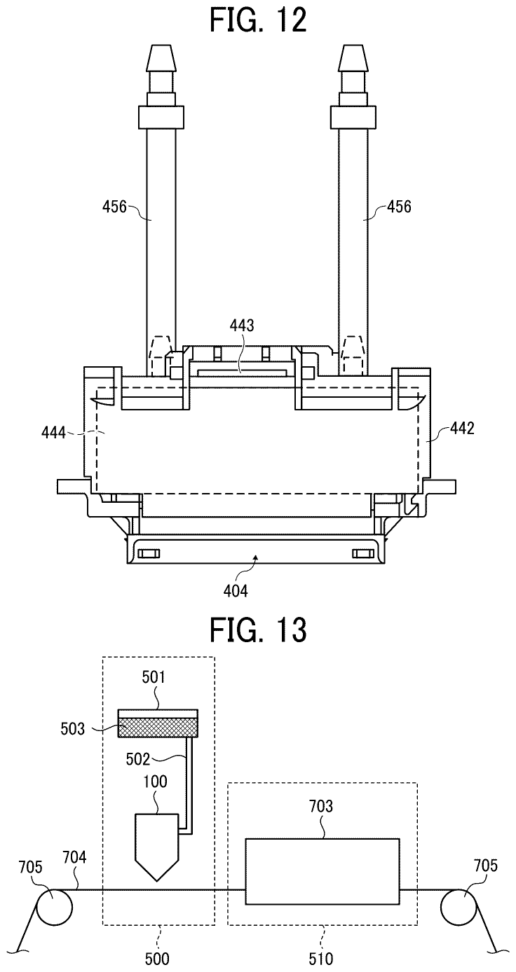

Still another liquid discharge unit is described below with reference to FIG. 12. FIG. 12 is a front view of the liquid discharge unit. The liquid discharge unit includes the liquid discharge head device 404 to which a channel component 444 is attached, and tubes 456 connected to the channel component 444. The channel component 444 is disposed inside a cover 442. Alternatively, the liquid discharge unit may include the head tank 441 instead of the channel component 444. A connector 443 for electrically connecting to the liquid discharge head device 404 is disposed on an upper portion of the channel component 444.

In the above-described embodiments, the “liquid discharge apparatus” includes the liquid discharge head, the liquid discharge head device, or the liquid discharge unit and drives the liquid discharge head to discharge liquid.

The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a medium onto which liquid is discharged (i.e. a discharge target medium) such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The “liquid discharge apparatus” may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The liquid discharge apparatus may also include an apparatus for manufacturing an electrode and an electrochemical element that is also referred to as an electrode manufacturing apparatus. The electrode manufacturing apparatus is described below.

FIG. 13 is a schematic view of an electrode manufacturing apparatus. The electrode manufacturing apparatus is an apparatus for manufacturing an electrode including a layer containing an electrode material by discharging a liquid composition using a head module including a liquid discharge head.

A discharge device in the electrode manufacturing apparatus illustrated in FIG. 13 is the head module including the liquid discharge head 100 (including modifications) described above. The liquid discharge head 100 of the head module discharges a liquid composition. By so doing, the liquid composition is applied onto the discharge target medium, and a liquid composition layer is formed on the discharge target medium. The discharge target medium is not limited and may be appropriately selected depending on the intended purpose, as long as the discharge target medium is an object on which a layer containing an electrode material is to be formed.

Examples of the discharge target medium include an electrode substrate, i.e., a current collector, an active material layer, and a layer containing a solid electrode material. The discharge target medium may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on the discharge target medium. The discharge device and the discharge process may be a device and a process of forming a layer containing an electrode material by indirectly discharging a liquid composition.

Other configurations included in the electrode manufacturing apparatus for manufacturing an electrode composite layer are not limited to any particular configuration and may be appropriately selected depending on the intended purpose. Other processes included in the method for manufacturing an electrode composite layer are not limited to any particular process and may be appropriately selected depending on the intended purpose. For example, a heating device and a heating process are examples of the configuration and the process included in the electrode manufacturing apparatus and the manufacturing method of the electrode composite layer.

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

As an example of the electrode manufacturing apparatus, an electrode manufacturing apparatus that forms an electrode composite layer containing an active material on an electrode substrate, i.e., a current collector, is described below.

As illustrated in FIG. 13, the electrode manufacturing apparatus includes a discharge process device 500 and a heating process device 510. The discharge process device 500 performs a discharge process of applying a liquid composition onto a print base material 704 having a discharge target medium to form a liquid composition layer. The heating process device 510 performs a heating process of heating the liquid composition layer to obtain an electrode composite layer.

The electrode manufacturing apparatus includes a conveyor 705 that conveys the print base material 704 (i.e., a medium). The conveyor 705 conveys the print base material 704 to the discharge process device 500 and the heating process device 510 in this order at a preset speed. A method of producing the print base material 704 having the discharge target medium such as an active material layer is not limited to any particular method, and a known method can be appropriately selected. The discharge process device 500 includes the liquid discharge head 100 that performs an application process of applying a liquid composition 503 onto the print base material 704, a storage container 501 that stores the liquid composition 503, and a supply tube 502 that supplies the liquid composition 503 stored in the storage container 501 to the liquid discharge head 100.

The discharge process device 500 discharges the liquid composition 503 from the liquid discharge head 100 so that the liquid composition 503 is applied onto the print base material 704 to form a liquid composition layer in a thin film shape. The storage container 501 may be integrated with the electrode manufacturing apparatus that forms the electrode composite layer or may be detachable from the electrode manufacturing apparatus. The storage container 501 may be a container additionally attachable to a container integrated with the electrode manufacturing apparatus for manufacturing the electrode composite layer or to a container detachable from the electrode manufacturing apparatus for manufacturing the electrode composite layer. The storage container 501 that stably stores the liquid composition 503 and the supply tube 502 that stably supplies the liquid composition 503 can be used.

The heating process device 510 performs a solvent removal process of heating and removing the solvent remaining in the liquid composition layer. Specifically, the solvent that remains in the liquid composition layer is heated and dried by a heater 703 of the heating process device 510. Accordingly, the solvent is removed from the liquid composition layer. Thus, the electrode composite layer is formed. The heating process device 510 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 503 or the thickness of a formed film.

The electrode manufacturing apparatus is used to discharge the liquid composition to a desired position on the discharge target medium. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a liquid discharge head device (liquid discharge head) and a head tank are integrated, as illustrated in FIG. 10. Alternatively, the liquid discharge head device and the head tank coupled (connected) to each other, for example, via a tube may form the liquid discharge unit as a single unit. A unit including a filter may further be added to a portion between the head tank and the liquid discharge head device of the liquid discharge unit.

In another example, the liquid discharge unit may be an integrated unit in which a liquid discharge head device is integrated with a carriage.

As yet another example, the liquid discharge unit is a unit in which the liquid discharge head device and the main-scanning moving mechanism are combined into a single unit. The liquid discharge head device is movably held by a guide that is a part of the main-scanning moving mechanism. Like the liquid discharge unit illustrated in FIG. 11, the liquid discharge head device, the carriage, and the main-scanning moving mechanism may form the liquid discharge unit as a single unit.

In another example, the cap that forms a part of the maintenance mechanism is fixed to the carriage mounting the liquid discharge head device so that the liquid discharge head device, the carriage, and the maintenance mechanism are integrated as a single unit to form the liquid discharge unit.

Further, in still another example, the liquid discharge unit includes tubes connected to the liquid discharge head device to which the head tank or the channel component is attached so that the liquid discharge head device and the supply mechanism are integrated as a single unit, as illustrated in FIG. 12.

The main-scanning moving mechanism may be a guide only. The supply mechanism may be a tube(s) only or a loading device only.

The actuator element used in the liquid discharge head is not limited to a particular type of pressure generator. The pressure generator is not limited to the piezoelectric element (or a laminated piezoelectric element) described in the above-described embodiments, and may be, for example, a thermal actuator that employs an electrothermal transducer, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

The embodiments described above are presented as examples and are not intended to limit the scope of the present disclosure. The above-described novel embodiments can be implemented in other various forms, and various omissions, replacements, and changes can be made without departing from the scope of the disclosure. These embodiments and modifications or variations thereof are included in the scope and gist of the present disclosure, and are included in the scope of claims and the equivalent scope thereof.

The embodiments described above are merely examples, and the aspects of the present disclosure exert the respective effects as follows.

### Aspect 1

According to Aspect 1, a liquid discharge head device (e.g., the head array 51) includes the liquid discharge head 100 that discharges a liquid from the nozzle 104a formed on the nozzle face 101a to a discharge target medium (e.g., the continuous sheet 10) being conveyed. The liquid discharge head device further includes a head holder (e.g., the base 52) that holds the liquid discharge head while causing the nozzle face to face the discharge target medium. The head holder has the exhaust ports 53-1A, 53-1B, 53-2A, and 53-2B at an opposing portion facing the discharge target medium.

In other words, a liquid discharge head device includes a liquid discharge head and a head holder. The liquid discharge head has a nozzle face having a nozzle to discharge a liquid, from the nozzle in a discharge direction, onto a discharge target conveyed in a conveyance direction orthogonal to the discharge direction. The head holder holds the liquid discharge head having the nozzle face facing in the discharge direction. The head holder has an opposing face facing in the discharge direction and an exhaust port on the opposing face and in a vicinity of the nozzle face.

In the comparative example, the exhaust device is disposed on each of the upstream side and the downstream side of the liquid discharge head device in the conveyance direction of the discharge target medium. The exhaust device exhausts air containing water vapor from the exhaust port of the exhaust device. In this configuration, the exhaust port is too far from the nozzle face of the liquid discharge head to sufficiently exhaust the air (e.g., air containing water vapor or ink mist) around the nozzle face. As a result, liquid (e.g., condensed liquid), such as water droplets and ink droplets, may adhere to the nozzle face. If the momentum of the airflow sucked from the exhaust port is increased to sufficiently exhaust the air around the nozzle face, a discharge direction of the liquid to be discharged from the nozzle may be changed by the airflow, and appropriate liquid discharge is hindered.

In the present aspect, the exhaust port is disposed at the opposing portion of the head holder, which holds the liquid discharge head, facing the discharge target medium. According to this configuration, the exhaust port can be disposed at a position in the vicinity of the nozzle face of the liquid discharge head held by the head holder so as to face the discharge target medium. Such a configuration can quickly exhaust the air around the nozzle face while keeping the momentum of the airflow sucked from the exhaust port within an appropriate range (within a range that does not hinder appropriate liquid discharge). Thus, according to the present aspect, liquid (e.g., condensed liquid), such as water droplets and ink droplets, can be prevented from adhering to the nozzle face without hindering appropriate liquid discharge.

### Aspect 2

According to Aspect 2, in the liquid discharge head device of Aspect 1, the head holder includes an exhaust channel 54 that guides airflow flowing through the exhaust port to an exhaust portion (e.g., the exhaust ducts 55A and 55B and the suction fans 56A and 56B).

In other words, the head holder has an exhaust channel connected to the exhaust port. The exhaust channel guides an air entered from the exhaust port in a direction parallel to the conveyance direction.

In addition, the liquid discharge head device further includes an exhaust device to exhaust the air around the nozzle face through the exhaust port and the exhaust channel.

According to this configuration, the airflow flowing through the exhaust port of the head holder can be guided to the exhaust portion (exhaust device) through the inside of the head holder (i.e., the exhaust channel 54).

### Aspect 3

According to Aspect 3, in the liquid discharge head device of Aspect 2, the opposing portion includes two plates (e.g., the upper plate 52A and the lower plate 52B) facing each other. The two plates are separated from each other. The exhaust port is open in the plate (e.g., the lower plate 52B) positioned on a side facing the discharge target medium among the two plates. The exhaust channel includes a space formed between the two plates.

In other words, the head holder includes a first plate having the opposing face having the exhaust port and a second plate facing the first plate with a gap between the first plate and the second plate in the discharge direction. The gap forms the exhaust channel.

According to this configuration, the exhaust channel 54 can be formed inside the head holder with a simple configuration.

### Aspect 4

According to Aspect 4, in the liquid discharge head device of any one of Aspects 1 to 3, the exhaust port is open at least at one of a position on an upstream side in a conveyance direction of the discharge target medium and a position on a downstream side in the conveyance direction of the discharge target medium with respect to the nozzle face.

In other words, the exhaust port has an opening on at least one of an upstream side or a downstream side of the nozzle face in the conveyance direction.

According to this configuration, in the liquid discharge head elongated in a direction (a width direction (sheet width direction) of the discharge target medium and a nozzle array direction) orthogonal to the conveyance direction of the discharge target medium, the air around the nozzle face can be exhausted from the exhaust port as compared with the case where the exhaust port is disposed at a position of an end portion of the liquid discharge head in the direction.

### Aspect 5

According to Aspect 5, in the liquid discharge head device of Aspect 4, the exhaust port is not open at a position on the upstream side in the conveyance direction of the discharge target medium with respect to the nozzle face, but is open at a position on the downstream side in the conveyance direction of the discharge target medium with respect to the nozzle face.

In other words, the exhaust port opens at a first position downstream from of the nozzle face in the conveyance direction and does not open at a second position upstream from the nozzle face in the conveyance direction.

According to this configuration, there is no exhaust port that is open at a position on the upstream side in the conveyance direction of the discharge target medium, which may disturb the conveyance airflow W2 generated by the conveyance of the discharge target medium. Accordingly, the exhaust efficiency of the air around the nozzle face by the exhaust port, which is open at the position on the downstream side in the conveyance direction of the discharge target medium, is not lowered due to such disturbance of the conveyance airflow W2, and thus the exhaust efficiency of the air around the nozzle face can be increased.

### Aspect 6

According to Aspect 6, in the liquid discharge head device of any one of Aspects 1 to 3, the head holder holds multiple liquid discharge heads 100-1 and 100-2 at different positions in the conveyance direction of the discharge target medium. The exhaust port is open at least at a position on a downstream side in the conveyance direction of the discharge target medium with respect to the nozzle face of the liquid discharge head (e.g., the downstream head 100-2) located on a most downstream side in the conveyance direction of the discharge target medium.

In other words, the liquid discharge head device according to any one of Aspects 1 to 3, further includes multiple liquid discharge heads including the liquid discharge head. The head holder holds the multiple liquid discharge heads at different positions in the conveyance direction of the discharge target. The exhaust port has an opening on a downstream side of the nozzle face of the most downstream liquid discharge head of the multiple liquid discharge heads in the conveyance direction.

According to this configuration, the air around each nozzle face of the multiple liquid discharge heads flowing downstream in the conveyance direction of the discharge target medium by the conveyance airflow W2 generated by the conveyance of the discharge target medium can be finally exhausted from the exhaust port which is open at the position on the downstream side in the conveyance direction of the discharge target medium with respect to the nozzle face of the liquid discharge head located on the most downstream side in the conveyance direction of the discharge target medium.

### Aspect 7

According to Aspect 7, in the liquid discharge head device of Aspect 6, the exhaust port is open at a position on a downstream side in the conveyance direction of the discharge target medium with respect to each nozzle face of the multiple liquid discharge heads.

In other words, the liquid discharge head device according to any one of Aspects 1 to 3, further includes multiple liquid discharge heads including the liquid discharge head. The head holder holds the multiple liquid discharge heads at different positions in the conveyance direction. The exhaust port has an opening on a downstream side of the nozzle face of each of the multiple liquid discharge heads in the conveyance direction.

According to this configuration, the air around each nozzle face of the multiple liquid discharge heads flowing downstream in the conveyance direction of the discharge target medium by the conveyance airflow W2 generated by the conveyance of the discharge target medium can be exhausted from each exhaust port which is open at the position on the downstream side in the conveyance direction of the discharge target medium with respect to each nozzle face.

### Aspect 8

According to Aspect 8, in the liquid discharge head device of Aspect 6, the exhaust ports 53-1B and 53-2B is opened at a position on an upstream side in the conveyance direction of the discharge target medium and a position on a downstream side in the conveyance direction of the discharge target medium with respect to a nozzle face of at least one liquid discharge head (e.g., the downstream head 100-2) among the multiple liquid discharge heads, respectively. A flow rate of airflow flowing into the exhaust port 53-2B which is open at the position on the downstream side in the conveyance direction of the discharge target medium is larger than a flow rate of airflow flowing into the exhaust port 53-1B which is open at the position on the upstream side in the conveyance direction of the discharge target medium.

In other words, the liquid discharge head device according to Aspect 2 or 3, further includes multiple liquid discharge heads including the liquid discharge head. The head holder holds the multiple liquid discharge heads at different positions in the conveyance direction. The head holder has multiple exhaust ports including the exhaust port. The multiple exhaust ports include a first exhaust port having a first opening on an upstream side of the nozzle face of at least one of the multiple liquid discharge heads in the conveyance direction, to exhaust the air at a first flow rate and a second exhaust port having a second opening on a downstream side of the nozzle face of the at least one of the multiple liquid discharge heads in the conveyance direction, to exhaust the air at a second flow rate larger than the first flow rate.

In this configuration, the conveyance airflow W2 that causes the air around the nozzle face of the at least one liquid discharge head to flow downstream in the conveyance direction of the discharge target medium may be disturbed by the suction airflow W1 of the exhaust port 53-1B which is open at the position on the upstream side in the conveyance direction of the discharge target medium with respect to the nozzle face. Due to the disturbance of the conveyance airflow W2, the exhaust efficiency of the air around the nozzle face by the exhaust port 53-2B which is open at the position on the downstream side in the conveyance direction of the discharge target medium with respect to the nozzle face may be lowered.

According to the present aspect, a decrease in the exhaust efficiency of the air around the nozzle face by the exhaust port 53-2B which is open at the position on the downstream side in the conveyance direction of the discharge target medium with respect to the nozzle face can be prevented.

### Aspect 9

According to Aspect 9, a liquid discharge unit includes the liquid discharge head device of any one of Aspects 1 to 8.

In other words, a liquid discharge unit includes the liquid discharge head device according to any one of Aspects 1 to 8 and a carriage mounting the liquid discharge head device to move the liquid discharge head device relative to the discharge target medium.

According to the present aspect, a liquid discharge unit can be provided that prevents liquid (e.g., condensed liquid), such as water droplets and ink droplets, from adhering to the nozzle face without hindering appropriate liquid discharge.

### Aspect 10

According to Aspect 10, a liquid discharge apparatus includes the liquid discharge head device of any one of Aspects 1 to 8 or the liquid discharge unit of Aspect 9.

In other words, a liquid discharge apparatus includes the liquid discharge head device according to any one of Aspects 1 to 8 and a conveyor to convey the discharge target medium to the liquid discharge head device.

According to the present aspect, a liquid discharge apparatus can be provided that prevents liquid (e.g., condensed liquid), such as water droplets and ink droplets, from adhering to the nozzle face without hindering appropriate liquid discharge.

According to one aspect of the present disclosure, liquid (e.g., condensed liquid), such as water droplets and ink droplets, can be prevented from adhering to the nozzle face without hindering appropriate liquid discharge.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head device comprising:
a liquid discharge head having a nozzle face having a nozzle to discharge a liquid, from the nozzle in a discharge direction, onto a discharge target conveyed in a conveyance direction orthogonal to the discharge direction; and
a head holder holding the liquid discharge head having the nozzle face facing in the discharge direction,
the head holder having:
an opposing face facing in the discharge direction; and
an exhaust port on the opposing face and in a vicinity of the nozzle face.

2. The liquid discharge head device according to claim 1,
wherein the head holder has an exhaust channel connected to the exhaust port, and
the exhaust channel guides an air entered from the exhaust port in a direction parallel to the conveyance direction.

3. The liquid discharge head device according to claim 2,
further comprising an exhaust device to exhaust the air around the nozzle face through the exhaust port and the exhaust channel.

4. The liquid discharge head device according to claim 2,
wherein the head holder includes:
a first plate having the opposing face having the exhaust port; and
a second plate facing the first plate with a gap between the first plate and the second plate in the discharge direction,
the gap forms the exhaust channel.

5. The liquid discharge head device according to claim 1,
wherein the exhaust port has an opening on at least one of:
an upstream side; or
a downstream side,
of the nozzle face in the conveyance direction.

6. The liquid discharge head device according to claim 5,
wherein the exhaust port:
opens at a first position downstream from of the nozzle face in the conveyance direction; and
does not open at a second position upstream from the nozzle face in the conveyance direction.

7. The liquid discharge head device according to claim 1, further comprising multiple liquid discharge heads including the liquid discharge head,
wherein the head holder holds the multiple liquid discharge heads at different positions in the conveyance direction of the discharge target, and
the exhaust port has an opening on a downstream side of the nozzle face of the most downstream liquid discharge head of the multiple liquid discharge heads in the conveyance direction.

8. The liquid discharge head device according to claim 1, further comprising multiple liquid discharge heads including the liquid discharge head,
wherein the head holder holds the multiple liquid discharge heads at different positions in the conveyance direction, and
the exhaust port has an opening on a downstream side of the nozzle face of each of the multiple liquid discharge heads in the conveyance direction.

9. The liquid discharge head device according to claim 2, further comprising multiple liquid discharge heads including the liquid discharge head,
wherein the head holder holds the multiple liquid discharge heads at different positions in the conveyance direction,
the head holder has multiple exhaust ports including the exhaust port,
the multiple exhaust ports include:
a first exhaust port having a first opening on an upstream side of the nozzle face of at least one of the multiple liquid discharge heads in the conveyance direction, to exhaust the air at a first flow rate; and
a second exhaust port having a second opening on a downstream side of the nozzle face of the at least one of the multiple liquid discharge heads in the conveyance direction, to exhaust the air at a second flow rate larger than the first flow rate.

10. A liquid discharge unit comprising:
the liquid discharge head device according to claim 1; and
a carriage mounting the liquid discharge head device to move the liquid discharge head device relative to the discharge target.

11. A liquid discharge apparatus comprising:
the liquid discharge head device according to claim 1; and
a conveyor to convey the discharge target to the liquid discharge head device.
